(19) United States
(12) Patent Application Publication
(10) Pub. No.: US 2014/0198619 A1
(43) Pub. Date: Jul. 17, 2014

(54) ULTRASOUND MEASUREMENT ASSEMBLY FOR MULTIDIRECTIONAL MEASUREMENT

(71) Applicants: Wililam John Lamb, Eindhoven (NL); Biju Kumar Sreedharan Nair, Veldhoven (NL)

(72) Inventors: Wililam John Lamb, Eindhoven (NL); Biju Kumar Sreedharan Nair, Veldhoven (NL)

(73) Assignee: KONINKLIJKE PHILIPS N.V., EINDHOVEN (NL)

(21) Appl. No.: 14/240,035

(22) PCT Filed: Sep. 14, 2012
(86) PCT No.: PCT/IB2012/054793

§ 371 Date: Feb. 21, 2014

Related U.S. Application Data
(60) Provisional application No. 61/537,714, filed on Sep. 22, 2011.

(51) Int. Cl. G01S 15/08

(52) U.S. Cl. CPC G01S 15/08
USPC 367/99

(57) ABSTRACT

The present invention relates to an ultrasound measurement assembly (10) and an according method for performing an ultrasound measurement. It is intended to drive an ultrasound transmitter element (18) for transmitting ultrasound waves, with a driving signal having a plurality of different driving frequencies simultaneously. Herein a driving least one corresponding ultrasound transmitter element (18): unit (12) is generating at least one driving signal (20) for at As an effect each ultrasound transmitter element (18) will generate a multidirectional ultrasound wave. Additionally it is intended to design a driving signal 20 in a way, that an overall ultrasound beam comprises individual frequency spectra in different spatial directions (22). If a part of overall ultrasound beam is reflected, a sensing signal (30) is generated by a sensing unit (28). The sensing signal (30) is comprised an individual frequency spectrum. The sensing signal is received by a processing unit which determines the frequency spectrum and therefore can determine to which spatial direction (22) or spatial region the signal was sent.

### FIELD OF THE INVENTION

The present invention relates to an ultrasound measurement assembly and a method for performing an ultrasound measurement. The invention also relates to an ultrasound transmitter for the ultrasound measurement assembly and to a sensing assembly for an ultrasound measurement assembly.

### BACKGROUND OF THE INVENTION

U.S. Pat. No. 6,549,487 B2 describes a vehicle occupant sensor which utilizes an acoustic system for determining object range, extent and direction. The system is composed of an ultrasonic transmitter formed from an array of air chamber resonator elements driven in relative phase to each other to produce a steered acoustic beam. In that, a raster scan can be provided by steering the acoustic beam in different spatial directions and perform a plurality of measurements in different spatial directions. The transducer array is tuned to a single resonance frequency to transmit the acoustic beam.

The raster scan is needed, since the ultrasonic beam is relatively narrow as to provide a high angular resolution. A disadvantage of this approach is a delay when scanning a big angular spread with the narrow beam, since the acoustic beam has to be steered through the whole angular spread in small steps, wherein individual measurements are made. Therefore, this standard raster scanning approach must trade angular resolution against latency.

### SUMMARY OF THE INVENTION

It is an object of the present invention to provide a device and a method of the types mentioned above enabling an ultrasound measurement with a small latency for measuring within an observation window.

In a first aspect of the present invention an ultrasound measurement assembly is presented, including an ultrasound transmitter element for transmitting ultrasound waves, a driving unit for driving the ultrasound transmitter element, wherein the driving unit is adapted to drive the ultrasound transmitter element with a driving signal having a plurality of different driving frequencies simultaneously, a sensing unit for sensing ultrasound waves and for generating a sensing signal in response to sensed ultrasound waves, and a processing unit for receiving the sensing signal and for determining a frequency spectrum of the sensing signal.

In a further aspect of the present invention an ultrasound transmitter is presented for an ultrasound measurement assembly, including an ultrasound transmitter element for transmitting ultrasound waves, and a driving unit for driving the ultrasound transmitter element, wherein the driving unit is adapted to drive the ultrasound transmitter element with the driving signal having a plurality of different driving frequencies simultaneously.

In a further aspect of the present invention a sensing assembly is presented for an ultrasound measurement assembly, including a sensing unit for sensing ultrasound waves and for generating a sensing signal in response to sensed ultrasound waves, and a processing unit for receiving the sensing signal and for determining a frequency spectrum of the sensing signal.

In a further aspect of the present invention a method is presented for performing an ultrasound measurement, including the steps of providing an ultrasound transmitter element for transmitting ultrasound waves, generating a driving signal having a plurality of different driving frequencies simultaneously, driving the at least one ultrasound transmitter element with the driving signal, sensing ultrasound waves, generating a sensing signal in response to sensed ultrasound waves, and determining a frequency spectrum of the sensing signal.

The invention is based on the idea to drive the ultrasound transmitter element with a driving signal comprising a plurality of different driving frequencies simultaneously.

As an effect, multiple ultrasound waves with different ultrasound frequencies are generated simultaneously with the driven ultrasound transmitter element. Based on physical relationships, those ultrasound waves of different frequencies are sent into different angular ranges, such that over any given angle the frequency spectrum of the transmission is differing. An object located at a specific angle relative to the ultrasound transmitter element will therefore reflect an ultrasound signal with an individual frequency composition. This individual frequency composition can be used by the processing unit to identify the relative angular location of the object. Given that the size of the reflecting object will also determine the range of frequencies reflected by the object, the spatial extent of the reflecting object can also be estimated.

It is an advantage of this approach that latency is greatly reduced in view of the prior art. The entire observation window of the transmitter element can be scanned in one transmission and one receiving step. Hence, an ultrasound measurement can be completed many times faster than with existing raster scanning approaches.

The ultrasound transmitter element forms an ultrasound transducer. Typically the ultrasound transmitter element is a piezoelectric element which is driven by an alternating signal, e.g. an alternating voltage. The ultrasound transmitter element may also be of another type, e.g. a piezo ceramic element, a piezo electric polymer element, an electrostatic transducer or a magnetostrictive transducer. The driving signal is therefore preferred to be an alternating voltage, alternating with different frequencies simultaneously, wherein the different frequencies are superimposed. Alternatively, the driving signal can be an alternating current, e.g. for driving magnetostrictive transmitter elements or for conventional loudspeakers. Hence, the ultrasound transmitter element is forming said ultrasound waves with different spatial ranges. The frequencies are typically frequencies in a range from 20 kHz to 100 kHz. More preferably, they are within a range of 30 kHz to 80 kHz. Additionally, it is preferred to generate the driving signal with a plurality of driving frequencies arranged in one compact band of frequencies. Alternatively, a plurality of frequency bands can be used.

Furthermore, it has to be taken into account what kind of geometrical structure the ultrasound transmitter element comprises and into which medium the ultrasound waves are transmitted. For ultrasonic frequencies whose wavelength is equivalent to, or larger than the dimensions of the ultrasound transmitter element, a beam pattern will be created which is substantially omnidirectional. For frequencies whose wavelength of the transmitted ultrasound wave is much shorter than dimensions of the ultrasound transmitter element, the beam pattern will form a narrow lobe in a forward direction to the ultrasound transmitter element, more particularly in an on-axis direction of the emission surface of the ultrasound transmitter element. Thus, by choosing a variety of frequencies, some frequencies will be transmitted with an omnidirectional radiation characteristic and some frequencies will be transmitted in a narrow beam. At various angles relative to the on-axis direction of the ultrasound transmitter element the frequency response of the transmitted beam will therefore be seen to differ substantially.

After sending out ultrasound waves, objects in range of the ultrasound transmitter element will reflect those ultrasound waves. Those reflected waves can then be sensed by the sensing unit which generates a sensing signal also comprising a plurality of different frequencies. The actual composition of the frequencies depends on the spatial position of the object reflecting the ultrasound wave relatively to the ultrasound transmitter element.

The processing unit can receive the sensing signal and determine the frequency spectrum of the sensing signal. By analyzing the frequency spectrum it is possible to identify a spatial direction or at least a spatial region of which the ultrasound wave has been reflected from.

Hence, a device and a method is gained for transmitting one approximately omnidirectional beam into a spatial region and to determine from which direction an ultrasound wave is reflected from in one transmission and one receiving operation. Hence, the invention leads to a reduction of latency in view of the prior art providing a high angular resolution.

Preferred embodiments of the invention are defined in the dependent claims. It shall be understood that the claimed method has similar and/or identical preferred embodiments as the claimed device and as defined in the dependent claims.

In an embodiment, the processing unit is adapted to compare the frequency spectrum of the sensed signal to at least one characteristic frequency spectrum corresponding to a spatial direction for identifying at least one directional signal.

In this embodiment the characteristic frequency spectrum is known for different spatial directions relative to the ultrasound transmitter element. The characteristic frequency spectrum can figuratively be understood as a known “fingerprint” of an ultrasound wave for a specific direction or region. In a preferred embodiment a plurality of characteristic frequency spectra are predefined and stored in storing means of the processing unit. The processing unit is adapted in this case to determine the frequency spectrum of the sensing signal and to compare this frequency spectrum to the stored characteristic frequency spectra. It is further preferred if a maximum likelihood estimator is used for comparing the frequency spectrum of the sensed signal to the characteristic frequency spectra, since it is unlikely to find an exact match between the frequency spectrum of the sensed signal and a characteristic frequency spectrum. This is caused for example by noise or changing characteristics of the travelling medium the ultrasound wave is transmitted through.

Hence, it is possible to obtain the direction signal including the information of the spatial point and/or range of origin. The directional signal can then be used for further analysis. Additionally, it is possible to divide a plurality of different ultrasound waves sensed simultaneously but with different spatial origins by comparing the frequency spectrum with the characteristic frequency spectra. Those ultrasound waves sensed simultaneously lead to a superimposed sensing signal, which can be divided based on the knowledge of characteristic frequency spectra as to generate directional signals for each sensed ultrasound wave corresponding to its origin.

In a further embodiment the processing unit is adapted to perform a time of flight calculation for the at least one directional signal. In that it is possible to estimate a distance of the reflecting object from the ultrasound transmitter element. Hence, the device and the method provide the possibility of estimating a spatial position of a reflecting element with respect to the ultrasound measurement assembly.

In a further embodiment the processing unit is adapted to compare the frequency spectrum of the sensed signal to at least one characteristic frequency content corresponding to a spatial range for calculating at least one spatial area of origin. In this embodiment a size of the reflecting object is calculated. Since the frequency spectra of the ultrasound waves change over an angular spread—seen from the ultrasound transmitter element—it can be determined what angular section is covered by the reflecting object. Based on this angular section and a distance from the reflecting object to the transmitter element, the size of the reflecting object can be estimated. As to determine the angular section, the sensing signal is analyzed for its frequency spectrum. If the frequency spectrum comprises a frequency content relating to a plurality of characteristic frequency spectra in a known interval, it can be assumed that the reflecting object is covering a specific angular section. This size estimation can be performed by noting that at a given distance a small object has a smaller angular size than a large object. Therefore, the large object will reflect a larger angular spread of signal back to the sensing unit then a small object. A larger object will therefore reflect a signal with different frequency content than a small object at the same angular location and same distance. Using the ranging data the size of an object at any arbitrary location within the observation window can be estimated.

In a further embodiment the ultrasound measurement assembly includes a plurality of ultrasound transmitter elements arranged in at least one array. In this embodiment the ultrasound measurement assembly comprises an ultrasound transducer having the plurality of ultrasound transmitter elements. Preferably, all of the ultrasound transmitter elements are driven by at least one driving signal having a plurality of different driving frequencies simultaneously. By using the array of ultrasound transmitter elements it is possible to perform a two-dimensional ultrasound scan. Based on the multi-dimensional character of the ultrasound waves, a two-dimensional scan can be provided very quickly. Further, the ultrasound transducer can comprise a plurality of arrays, wherein the ultrasound transmitter elements are preferably arranged in a matrix structure. Hence, it is possible to perform a three-dimensional ultrasound measurement with high resolution and low latency.

In a further embodiment the driving unit is adapted to drive each ultrasound transmitter element individually. In this embodiment each ultrasound transmitter element is driven individually. This gives the advantage of transmitting ultrasound waves from each ultrasound transmitter element individually. Hence, a spatial measurement resolution can be enhanced. It is also possible to combine the usage of the driving signals having the plurality of different driving frequencies simultaneously with a phase shifting approach. In that the multi-directional ultrasound wave beam can additionally be focused and/or steered when needed

In a further embodiment the driving unit is adapted to generate individual driving signals for each ultrasound transmitter element, each individual driving signal having an individual composition of different driving frequencies. By generating different driving signals with their individual compositions of different driving frequencies, it is possible to shape the resulting ultrasound beam of the ultrasound transmitter element array or ultrasound transmitter element matrix in an asymmetrical way, preferably the resulting overall ultrasound beam is asymmetrically shaped into every spatial direction it is transmitted to. The term “shaping” relates to manufacturing the composition of frequencies individually for a spatial direction. Hence, the processing unit can determine very exactly and with high certainty from which spatial direction or from which spatial region ultrasound signals are reflected from. The usage of individual driving signals with individual compositions of different driving frequencies leads to a very high freedom of design as to produce an overall ultrasound beam with a plurality of ultrasound wavelength and characteristic frequency compositions in different spatial regions as needed for an individual application. Hence, it is possible to spare unnecessary spatial regions and to enhance a resolution within regions of interest. Additionally, it is possible to divide the plurality of ultrasound transmitter elements into groups which cover specific spatial regions with a very high resolution.

In a further embodiment the individual driving signals are adapted to drive the corresponding ultrasound transmitter elements to transmit ultrasound waves in at least two different spatial directions. Hence, this embodiment provides the possibility of covering different spatial regions individually with one array or matrix of transmitter elements.

In a still further embodiment the driving unit comprises at least one frequency filter for receiving a basic signal having a plurality of different driving frequencies and for filtering the basic signal generating at least one of the individual driving signals. In that it is possible to shape the overall ultrasound beam of the ultrasound transmitter elements by designing a plurality of frequency filters. It is preferred, if the frequency filters are FIR filters. FIR filters allow a phase and a frequency response of the driving signal to be controlled in a simple way. It is advantageous that one basic broad bandwidth input signal can be generated and can be received by each frequency filter. Each frequency filter attenuates unwanted frequencies, and/or alters the phase angle of the driving signal at a particular frequency or set of frequencies to generate the driving signal having the desired plurality of different driving frequencies and phase angles for its corresponding ultrasound transmitter element. Moreover, it is preferred, if the frequency filters can be changed in their frequency filtering or phase altering characteristic while performing the measurement or while using the ultrasound measurement assembly. Hence, the radiation pattern of the ultrasound transmitter element array or matrix can be adapted while using the ultrasound transmitter assembly. Therefore, regions of interest can be enhanced in their measurement resolution if desired, wherein an active approach is gained leading to dynamic measurements.

In a further embodiment the sensing unit is at least one microphone. In this embodiment one microphone is used as the sensing unit. Preferably the microphone is arranged near the at least one ultrasound transmitter element. Based on the inventive approach described above, it is possible to sense a plurality of reflected ultrasound waves of different spatial directions with one microphone. The microphone generates a broadband signal from the one ultrasound transmitter element or also from a plurality of the ultrasound transmitter elements as the sensing signal. Hence, a device and a method are gained which only need one microphone for measuring ultrasound waves from different spatial directions.

In a further embodiment the ultrasound measurement assembly includes a plurality of microphones arranged in at least one array. In this embodiment the sensing unit includes the plurality of microphones. They can be arranged in one linear array or in a plurality of arrays, e.g. forming a matrix of microphones. The plurality of microphones enhances a spatial measurement resolution of the sensing unit and the process of identifying different directional signals. A plurality of microphone arrays is preferably arranged near to the transmitting elements. This is advantageous, since a spatial angle corresponding to an on-axis angle of the at least one ultrasound transmitter element is the same or at least very similar. Hence, a position estimate can be made directly with relative spatial angles.

In a still further aspect of the present invention a system is proposed comprising an ultrasound measurement assembly according to the present invention and an evaluation unit for evaluating the determined frequency spectrum of the sensing signal.

Preferably, said system further comprises a control unit for controlling an electrical device, in particular a lighting device, an alarm device, a ranging device, a guidance device, a audio and/or video playback device or a vehicle, based on the result of said evaluation.

### BRIEF DESCRIPTION OF THE DRAWINGS

These and other aspects of the invention will be apparent from and elucidated with reference to the embodiment(s) described hereinafter. In the following drawings

FIG. 1 shows schematically a first embodiment of an ultrasound measurement assembly according to the invention,

FIG. 2 shows a piston source for generating ultrasound waves,

FIG. 3 shows a diagram of acoustic intensities as a function of an angle and frequency for the piston source according to FIG. 2,

FIG. 4 shows a diagram of frequency responses at different angles to the ultrasound piston source according to FIG. 2,

FIG. 5 shows a driving unit comprising a plurality of frequency filters,

FIG. 6 shows a diagram with an intensity of ultrasound waves as a function of an angle and frequency for an ultrasound transmitter element array, and

FIG. 7 shows schematically a system according to the present invention.

### DETAILED DESCRIPTION OF THE INVENTION

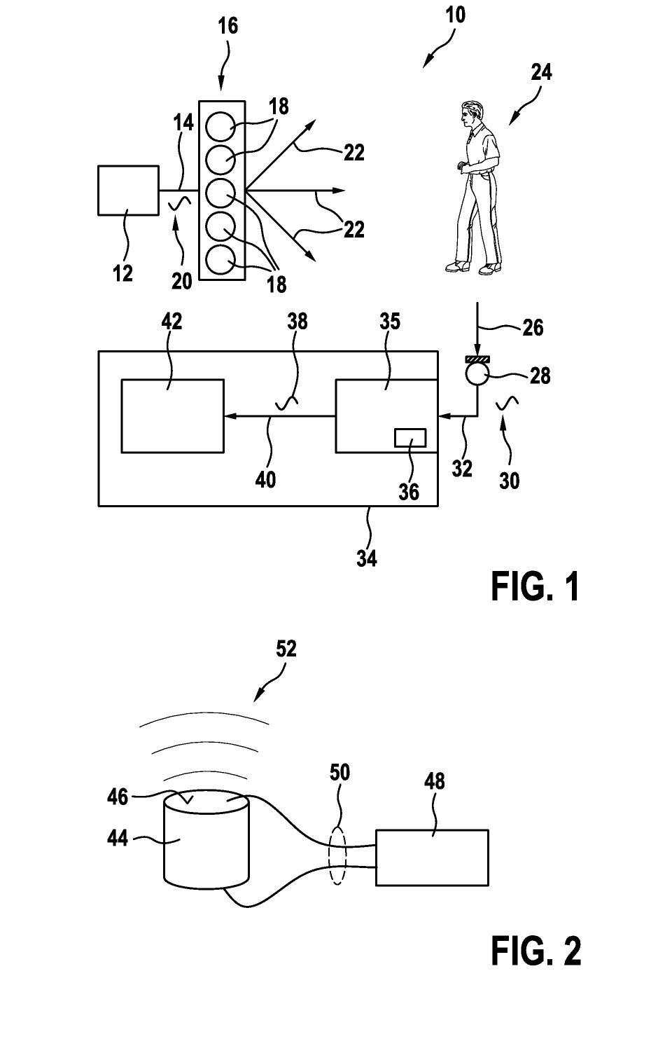

FIG. 1 shows an ultrasound measurement assembly 10 in a schematic view. It comprises a driving unit 12 which is connected via a line 14 to an array 16 of ultrasound transmitter elements 18, forming an ultrasound transducer. The driving unit 12 is generating a driving signal 20, which is transmitted via the line 14 to the ultrasound transmitter element array 16. The ultrasound transmitter elements 18 are driven by the driving signal 20, wherein they generate an ultrasound beam directed simultaneously into multiple directions 22. The ultrasound beam comprises a plurality of ultrasound waves of different wave lengths corresponding to the driving frequencies of the driving signal 20. As it will be explained later exemplarily, the different waves expand into different directions 22 according to a ratio between the wavelength and a dimension of each ultrasound transmitter element 18. Hence, in different spatial directions 22 different frequency spectra of ultrasound waves are transmitted.

The generated ultrasound beam is sent out until it is reflected by an object. As a reflecting subject a person 24 is shown. It should be understood, that a person is an example of a reflecting subject, but any ultrasound reflecting object can be used herein. The person 24 is reflecting the ultrasound wave into a direction 26 to a sensing unit in form of a single microphone 28. The microphone 28 is sensing the reflected ultrasound wave and generates a sensing signal 30 which is transmitted via a line 32 to a processing unit 34. The processing unit 34 comprises a first part 35 for receiving the sensing signal 30 and for determining the frequency spectrum of the sensing signal 30. Additionally, the first part 35 comprises storage means 36 which are storing data referring to different predefined characteristic frequency spectra. Further, the first part 35 compares the characteristic frequency spectra with the frequency spectrum of the sensed signal 30 as to identify into which spatial direction 22 the originated ultrasound wave was sent before being reflected to the microphone 28. Based on a maximum likelihood estimator the comparison is made and the direction is identified. The maximum likelihood estimator can also estimate in one step a number of objects, angles to these objects, size of the objects and distance to these objects.

Then a corresponding directional signal 38 is generated. The directional signal 38 comprises the information of the sensing signal 30 corresponding to its spatial direction 22 and information about which spatial direction 22 it is corresponding to. Additionally, it can comprise further information, e.g. all or parts of the information obtained by the maximum likelihood estimator. Further, the directional signal 38 is sent via a line 40 to a second part 42 of the processing unit 34. This second part 42 is adapted to analyze the directional signal 38. In particular, it performs a time of flight calculation as to determine the distance traveled by the reflected ultrasound wave. Hence, based on the knowledge of the direction 22 and the distance traveled by the ultrasonic wave, the position of the person 24 with respect to the ultrasound measurement assembly 10 can be calculated.

Additionally, the processing unit 34 compares the frequency spectrum of the sensed signal 30 to a plurality of characteristic frequency contents. These characteristic frequency contents are also stored within the storage means 36. Based on this frequency content it can be determined, what angular spread of the ultrasound waves transmitted from the array 16 has been reflected into the direction 26. Based on the information of the position of the reflecting person 24 and the angular spread, which was reflected, the extent of the person 24 in at least one spatial direction is calculated. This information is also transmitted through the line 40 to the second part 42 of the processing unit 34 for further analysis and/or outputting purposes.

In summary, ranging, angular location and size estimation is made possible by analyzing the ultrasound wave reflected by the person 24. To be able to correctly resolve these features it is preferred that the microphone 28 (or a corresponding microphone array) is collocated with the array 16. Ranging can be performed by standard time of flight techniques within the processing unit 34. Angular location estimates are performed by matching the frequency spectrum of the reflected ultrasound wave with the characteristic frequency spectra of the storage means 36. The closest match gives the most likely angular location of the reflecting person 24. In preferred embodiments a higher resolution is obtained by using interpolation methods and statistical processes to increase the angular resolution of the estimated angular location. Size estimates can be performed by noting that at a given distance a small subject 24 has a smaller angular size than a larger object. Therefore, the larger object will reflect a larger angular spread of ultrasound waves back to the microphone 24 than the small subject 24. A large object will therefore reflect a signal with a different frequency content compared to a small object at the same angular location and the same distance. Using the ranging data the size of an object or subject at any arbitrary location within the observation window can be estimated.

FIG. 2 shows a simple version of an ultrasound transmitter element 44. The ultrasound transmitter element 44 is a piston source 44 for ultrasound waves. It comprises a circular transmission surface 46 of approximately 8 mm in diameter. The piston source 44 is made of a piezoelectric material, which is driven by a driving unit 48. In alternative embodiments, the piston source could also be of a different type, e.g. an electrostatic ultrasound transmitter element, a magnetostrictive ultrasound transmitter element or any other transducer suitable for transmitting ultrasonic waves. The driving unit 48 generates an alternating voltage as a driving signal having a plurality of different driving frequencies simultaneously. This driving signal is sent via lines 50 to the piston source 44. Based on the frequencies of the alternating voltage transmitted through the lines 50, the piezoelectric element is contracting and expanding. Thereby ultrasound waves 52 are generated at the transmission surface 46.

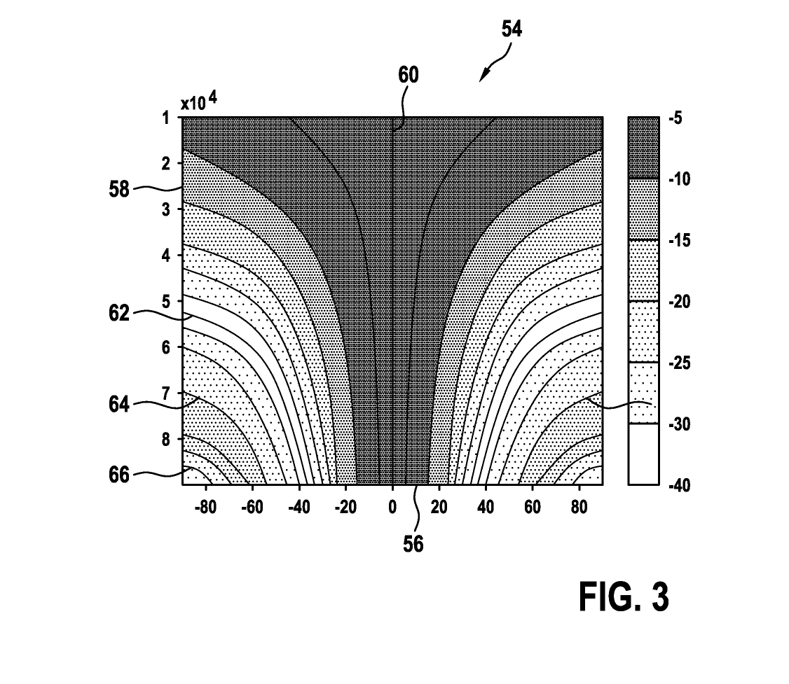

FIG. 3 shows schematically a directivity pattern of the piston source shown in FIG. 2. FIG. 3 shows a diagram 54 comprising an abscissa 56 referring to a transmission angle seen from the transmission surface 46, wherein the value zero describes an angle on-axis to the transmission surface 46. Additionally, the diagram 54 comprises an ordinate 58 describing different frequencies of the driving signal through the line 50. The abscissa 56 refers to the measurement unit degrees and the ordinates 58 refer to the measurement value Hertz. Within the diagram a plurality of lines are shown which are displaying constant values in a sound pressure level. For better visualization values of certain value intervals are depicted in the same way. It has to be understood that the values between the lines are actually changing with continuously varying gradients. Hence, a continuous and nonlinear change of the values is given in diagram 54.

A line 60 represents the highest points of value with a sound pressure level of −5 dB. Coming from the line 60 the sound pressure level is decreasing to a value of −40 dB at a further line 62. Then the next local maximum is given at line 64 with a value of −25 dB. From there the values are decreasing to line 66 with a value of −34 dB and falling. As shown, the line 60 is also a symmetry axis for the acoustic intensity to different sides to an angle on-axis to the sound transmitting surface 46 of the piston source 44.

Based on the physical relationship between the ultrasonic frequencies and the dimensions of the piston source 44, the beam pattern will be substantially omnidirectional.

This can be seen especially for the frequency of 10 kHz on top of the diagram. At this frequency the intensity does not differ very much over the whole angular spread from −90 to +90 degrees. For frequencies where the wavelength of the transmitted ultrasound is much shorter than dimensions of the piston source, the beam pattern will form a narrow lobe in the on-axis direction. This can be seen especially for the frequency of 90 kHz, in particular at the abscissa 56. Further, at this frequency, two side lobes are generated.

Thus, over the operational frequency range of the piston source 44, some frequencies will be transmitted with an omnidirectional radiation characteristic and some frequencies will be transmitted in a narrow beam. At various angles relative to the on-axis direction of the piston source 44, the frequency response of the transmitted beam 52 will therefore be substantially different. However, the more substantially the frequency spectrum will differ from one angle to a nearby angle, the higher measurement resolution will be achieved.

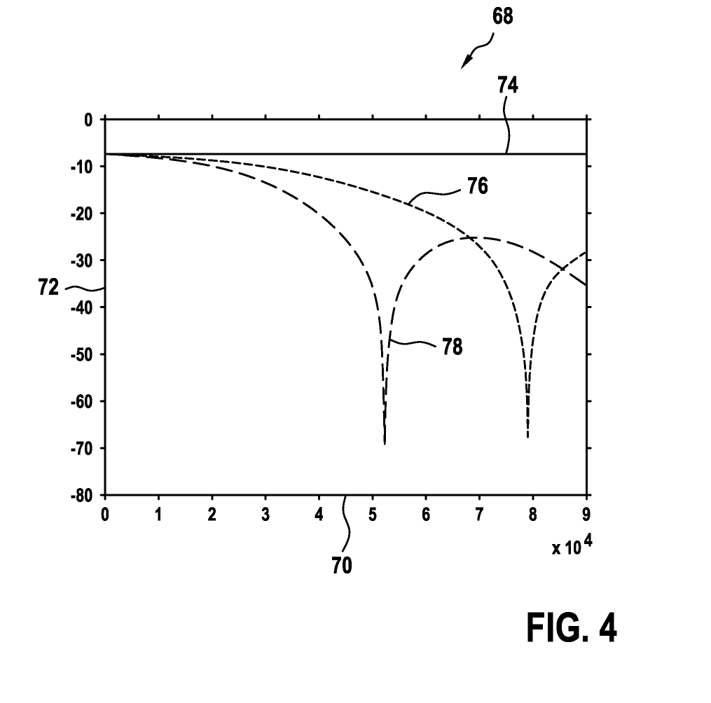

FIG. 4 shows a frequency response for different angles. In particular FIG. 4 shows a diagram 68 comprising an abscissa 70 and an ordinate 72. In this diagram 68 the abscissa 70 describes the frequency according to the ordinate 58 in FIG. 3. The ordinate 72 is describing the sound pressure level, which is described in FIG. 3 by the plurality of lines shown. The sound pressure level is here also given in the unit dB. Within the diagram 68 a first curve 74 is shown. This first curve 74 represents the progression of the sound pressure level at 0 degrees. It is shown that at 0 degrees the sound pressure level is constant for all frequencies.

Additionally, a second curve 76 is shown, which describes the progression of the sound pressure level of the piston source 44 at an angle of 40 degrees (and −40 degrees as well). Finally, a third curve 78 is shown, describing the progression of a sound pressure level for the piston source 44 at an angle of 80 degrees (respectively −80 degrees). As shown, any object located within an angular observation window of the piston source 44 will reflect a signal with a substantially different frequency response, having an individual frequency spectrum, depending on the angular location of the reflecting object relative to the piston source 44.

As this example describes the basic principle, it has to be understood that the frequency field comprises a rotational symmetry with respect to the on-axis of the transmission surface 46. This symmetry results in multiple locations in the acoustic field, where the frequency response is the same. This can be overcome by using a microphone array, wherein the reflected ultrasound wave arrives with small time differences between the elements. Those differences are sufficient to resolve this ambiguity under certain conditions. It is advantageous in this case that the sample rate of any analogue to digital converters is set at a rate sufficiently high to resolve an angular difference fine enough to remove ambiguities relating to the rotational symmetry of the ultrasonic transmission.

A sample rate fs (Hertz) denotes a number of samples acquired in a second. Thus a time interval T between samples is given by the 1/fs (seconds). The shortest time interval that can be measured by the system is therefore T seconds. Simple trigonometry allows a minimum sensing angle to be determined for a pair of microphones given the microphone spacing d

θ=arcsin(cT/d),

where θ is the minimum sensing angle in radians and c is the speed of sound in the medium (approx 343 m/s in air at S.T.P.). Conversely if it is already known that a minimum sensing angle is required the equation can be rearranged to determine the sample rate fs required by the system

fs=1/T=c/(d sin(θ)).

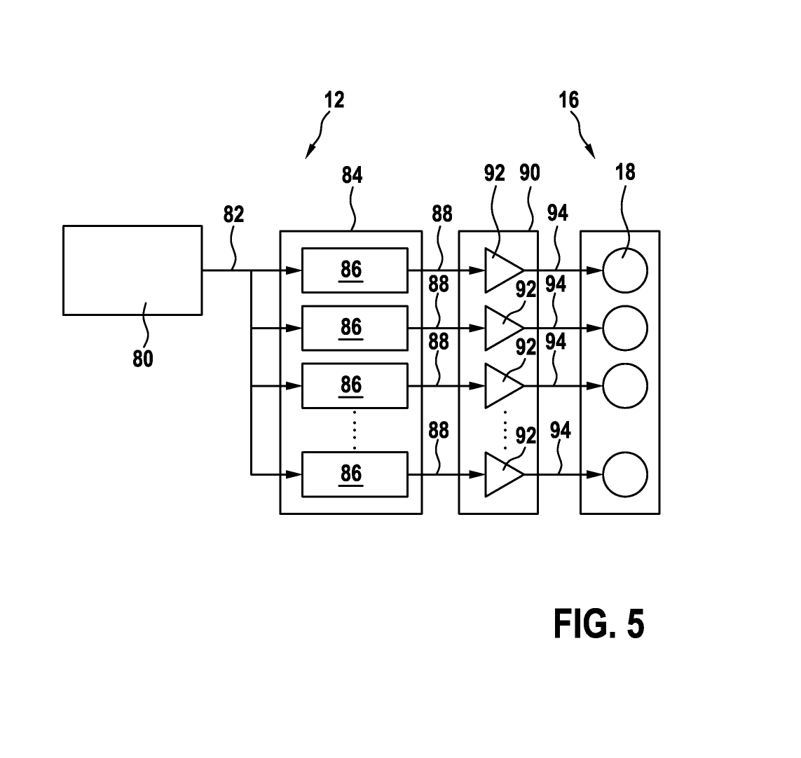

FIG. 5 shows the driving unit 12 of FIG. 1 and the ultrasound transmitter element array 16 of FIG. 1 in more detail. The usage of a plurality of ultrasound transmitter elements 18 arranged in the array 16 leads to a high spatial measurement resolution by actively controlling a directivity pattern of the transmitter array 16 to impart the required properties into an acoustic field. In other words, the acoustic field can be designed asymmetrically in a way that each spatial direction of the observation window comprises an individual composition of ultrasound frequencies. Reflected ultrasound waves are therefore uniquely identifiable. The ultrasound transmitter element array 16 sends ultrasound waves without ambiguity in different spatial directions and the angular resolution of the ultrasound measurement assembly can be made extremely high.

The driving unit 12 comprises a signal source 80. The signal source 80 generates a broad bandwidth input signal which is transmitted via a line 82 to a filter block 84. The filter block 84 comprises a plurality of FIR-filters 86. Each filter 86 is designed in an individual way as to generate a first signal with an individual composition of different driving frequencies. Each filter transmits its first signal through a corresponding line 88 to a multichannel amplifier 90. The multichannel amplifier 90 comprises a plurality of individual amplifiers 92. The amplifiers 92 amplify the first signals coming from the corresponding lines 88 individually. The amplified signals coming from the amplifiers 92 are individual driving signals transmitted via lines 94 to a corresponding transmitter element 18 of the ultrasound transmitter element array 16.

These FIR-filters 86 can be designed to provide an asymmetrical directivity pattern of the ultrasound beam generated by the ultrasound transmitter element array 16. As an effect each angular direction from the ultrasound transmitter element array 16 is sending a combined ultrasound wave with unique frequency spectrum. Additionally, it is possible to ensure that a rapid change of the frequency spectrum is given with changing angle. This rapid change with a changing angle provides a high angular resolution allowing small objects to be resolved very exactly. With such an array aliasing problems, which can be particularly problematic to systems described in the prior art, can be used to enhance the angular resolution of this invention.

In further embodiments it is conceivable that the sound field can be made asymmetrical in three dimensions to allow a three-dimensional ranging and localization over an observation window describing a solid angle. This can be achieved by using a two-dimensional transducer matrix. For example a transducer grid consisting of 8 by 8 ultrasonic transducer elements could be used to provide a very high angular resolution in a horizontal and a vertical plane.

The design of the FIR-filters is critical to the performance of the ultrasound measurement assembly. The design goals of the FIR-filters are to provide an asymmetrical directivity pattern whose frequency response varies rapidly with angle. This design of these

FIR-filters can be accomplished using a numerical optimization process. A target function T, depicting the desired frequency response at each angle of interest can be provided as the input to a numerical optimization problem, e.g. least mean squares optimization. The transfer matrix M (n, t) specifies the transfer function from each of the ultrasound transmitter elements 18 of the ultrasound transmitter element array 16 to each of t measurement points specified in the target function. This transfer function can be derived from a mathematical method or can be specified by taking measurements. To find the required complex phase responds at each transmitter element 18 the following matrix equation for a frequency vector x must be solved:

Mx=T.

This matrix equation can also be solved by numerical methods. In the event that no exact vector x exists for which Mx=T, an optimization procedure selects an optimum frequency vector x′ which provides the closest mathematical match to the target function T. This procedure must be done for each individual frequency of interest. Building up a complete frequency vector x′ over an entire frequency range allows to calculate the design of the FIR-filters 86. For example, time domain filter kernels may be derived by performing an inverse Fourier transform on the frequency domain data.

The multi-frequency beaming can be achieved by filtering the broad band input signal from the signal source 80 with the FIR-filters 86. This can be done either in the time domain or in the frequency domain.

Additionally, the filters should be designed to ensure that all ultrasound transmitter elements are driven within their safe limitations of operation as to prevent defects at the ultrasound transmitter elements. This can be done by applying boundary conditions to the optimization scheme to ensure that the power levels at each transducer never exceed the ratings.

The size of the reflecting subject 24 can be estimated by analyzing the frequency spectrum of the sensed signal 26. Comparing the spectrum of the sensed signal with the characteristic frequency spectrum can be done by comparing the frequency spectrum of the sensed signal with the target function t, or more appropriately T′, wherein:

Mx′=T′.

Herein x′ is the optimized filter set. It is possible to derive the angular location in an observed angular width of the object with respect to the location of the ultrasound transmitter element array 16.

Using time of flight information from the processing unit 34 for the directional signal, the distance to the subject 24 can be calculated. Using the distance to and the angular width of the reflecting object 24 with basic trigonometry the approximate size of the reflecting subject 24 can be calculated. This is especially useful for tracking purposes, for example a human would have a characteristic size and would easily be tracked. Objects larger or smaller than a human can be ignored by a control system using the ultrasound measurement assembly.

Comparing the frequency spectrum of the sensed signal with the target function can be fully automated using a maximum likelihood estimator. In this case the observed data Γ:

Γ=X(Θ)+η.

Therein Θ is a vector of all the parameters to be estimated, e.g. angular location, distance, size, etc. Further η is the noise estimate of the measurement system and X is a function operating on Θ to provide actual noise free system data. The likelihood function can be generated which gives a measure for how likely it would be to observe the data Γ given the noise η and a given set of actual system data X(Θ). By maximizing the likelihood, or using a logarithmic likelihood function, the most likely set of actual system data as can be derived. This is achieved when the parameters Θ are chosen such that the actual system data X(Θ) and noise estimate provides the best match for the measured data Γ. It is preferred to obtain this via a least mean square type optimization. Additionally, the number of parameters in Θ can be chosen to reflect the number of reflecting objects in the observation window, the angular location and size of these objects and the distance of these objects from the transmitter. The maximum likelihood optimization then gives the best estimate for all these quantities.

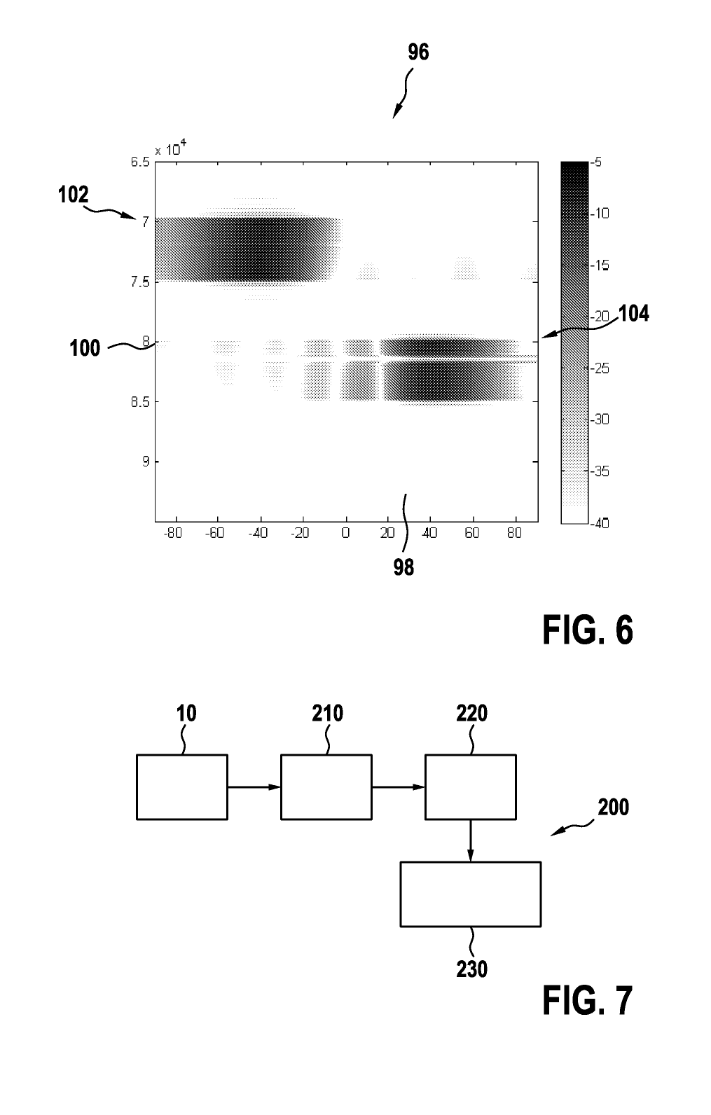

FIG. 6 shows a further diagram 96 with an abscissa 98 describing angles relative to the on-axis direction of an 8-element transducer array in degrees. It also comprises an ordinate 100 with frequencies in Hz. As shown, the 8-element array has been provided with driving signals which lead to a first ultrasound beam 102 and a second ultrasound beam 104. The first ultrasound beam 102 is transmitted within −90 to approximately −10 degrees relative to the on-axis direction. The second ultrasound beam 104 is transmitted approximately between −20 to 80 degrees relative to the on-axis direction. Both ultrasound beams 102 and 104 are therefore directed in different spatial directions. Additionally, the side lobes arising with those beams are of a small sound pressure level, wherein the beams 102 and 104 do not interfere in a relevant way. Hence, by designing the driving signals for each ultrasound transmitter element of the 8-element array, a specific spatial range can be covered by an individual beam exclusively.

FIG. 7 shows schematically an embodiment of a system 200 according to the present invention. The system 200 comprises an ultrasound measurement assembly 10 according to the present invention as described above and an evaluation unit 210 for evaluating the determined frequency spectrum of the sensing signal 30. The evaluation unit 210 may be a unit separated from the processing unit 34 (see FIG. 1) or may correspond to the second part 42 of the processing unit 34. Further, preferably, said system 200 comprises a control unit 220 for controlling an electrical device 230, in particular a lighting device, an alarm device, a ranging device, a guidance device, a audio and/or video playback device or a vehicle, based on the result of said evaluation performed in said evaluation unit 210. Preferred embodiments of the system 200 shall be explained with reference to a few particular exemplary (non-limiting) applications.

Preferred applications are the detections of human beings, objects and/or animals within a given space. The high accuracy and low latency allow for example to observe a large office space from relatively few sensors. Occupancy levels can be determined on a local basis allowing intelligent energy saving lighting control systems to direct light only to where it is required, as to say where a person is present or is heading to. Thus, the system of the present invention can be used to provide feedback to lighting systems in order not only to know if somebody is present, but also where persons are in a room so that they can be provided with optimal lighting at that point, and to reduce energy consumption by reducing light levels where it is not required.

Presence detection can be important in many areas such as alarm systems etc. Because the proposed system can accurately track the size and location of an object it could be possible to distinguish between cats/wild animals and actual human intruders.

As a further application the presence of persons could be detected in front of a television. In the absence of viewers, the television would be switched off automatically. Additionally, it would be of advantage to differentiate between the sizes of different viewers as to estimate their ages. This could be used to activate parental control if the user was estimated to be small, for example a child.

As a further application the range to and the angular location of a user and/or the number of users can also be used to control an output of a sound system, allowing an optimization of sound reproduction for example in a home cinema set up.

In yet a further application the low system latency allows tracking of multiple objects in real time in an extended observation window. This can be used for tracking individuals in a working environment. The system can also be used to provide an alert if somebody is detected approaching an out of bounds area, for example a dangerous working area of a machine.

As a further application the latency tracking can also be used as an input to control a machine. For example lighting controls can be made dimmable by simple gestures which are tracked with the ultrasound measurement assembly. The system could also be used on its own as an input device for personal computers and/or video game consoles or in conjunction with other technologies such as given video game controllers based on video camera or infrared tracking technology. By combining those controls with the intended ultrasound measurement assembly a more robust control system is gained with a higher accuracy and a lower latency.

Still further, the system can be used as a ranging and guidance system for robotic systems. The low latency of the present invention means that it could be ideally suited to this application. Finally, the proposed system can be provided as a parking sensor for a car, where the size of the obstacle as well as the distance could be reliably identified, i.e. a wall or bollard etc.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims.

In the claims, the word “comprising” does not exclude other elements or steps, and the indefinite article “a” or “an” does not exclude a plurality. A single element or other unit may fulfill the functions of several items recited in the claims. The mere fact that certain measures are recited in mutually different dependent claims does not indicate that a combination of these measures cannot be used to advantage.

Any reference signs in the claims should not be construed as limiting the scope.

1. Ultrasound measurement assembly, comprising:
an ultrasound transmitter element for transmitting ultrasound waves,
a driving unit for driving the ultrasound transmitter element, wherein the driving unit is adapted to drive the ultrasound transmitter element with a driving signal having a plurality of different driving frequencies simultaneously, wherein at least a first one of the driving frequencies is suitable for transmitting an ultrasound wave whose wavelength is shorter than dimensions of the ultrasound transmitter element, and wherein at least a second one of the driving frequencies is suitable for transmitting an ultrasound wave whose wavelength is equivalent to or larger than the dimensions of the ultrasound transmitter element
a sensing unit for sensing ultrasound waves and for generating a sensing signal in response to sensed ultrasound waves, and
a processing unit for receiving the sensing signal and for determining a frequency spectrum of the sensing signal.

2. Ultrasound measurement assembly as claimed in claim 1, wherein the processing unit is adapted to compare the frequency spectrum of the sensed signal to at least one characteristic frequency spectrum corresponding to a spatial direction for identifying at least one directional signal.

3. Ultrasound measurement assembly as claimed in claim 2, wherein the processing unit is adapted to perform a time of flight calculation for the at least one directional signal.

4. Ultrasound measurement assembly as claimed in claim 2, wherein the processing unit is adapted to compare the frequency spectrum of the sensed signal to at least one characteristic frequency content corresponding to a spatial range for calculating at least one spatial area of origin.

5. Ultrasound measurement assembly as claimed in claim 1, comprising a plurality of ultrasound transmitter elements arranged in at least one array.

6. Ultrasound measurement assembly as claimed in claim 5, wherein the driving unit is adapted to drive each ultrasound transmitter element individually.

7. Ultrasound measurement assembly as claimed in claim 6, wherein the driving unit is adapted to generate individual driving signals for each ultrasound transmitter element, each individual driving signal having an individual composition of different driving frequencies.

8. Ultrasound measurement assembly as claimed in claim 7, wherein the individual driving signals are adapted to drive the according ultrasound transmitter elements to transmit ultrasound waves in at least two different spatial directions.

9. Ultrasound measurement assembly as claimed in claim 7, wherein the driving unit comprises at least one frequency filter for receiving a basic signal having a plurality of different driving frequencies and for filtering the basic signal generating at least one of the individual driving signals.

10. Ultrasound measurement assembly as claimed in claim 1, wherein the sensing unit comprises at least one microphone, in particular a plurality of microphones arranged in at least one array.

11. Ultrasound transmitter for an ultrasound measurement assembly, comprising:
an ultrasound transmitter element for transmitting ultrasound waves, and
a driving unit for driving the ultrasound transmitter element, wherein the driving unit is adapted to drive the ultrasound transmitter element with a driving signal having a plurality of different driving frequencies simultaneously.

12. (canceled)

13. Method for performing an ultrasound measurement, comprising the steps of:
providing an ultrasound transmitter element for transmitting ultrasound waves,
generating a driving signal having a plurality of different driving frequencies simultaneously, wherein at least a first one of the driving frequencies is suitable for transmitting an ultrasound wave whose wavelength is shorter than dimensions of the ultrasound transmitter element, and wherein at least a second one of the driving frequencies is suitable for transmitting an ultrasound wave whose wavelength is equivalent to or larger than the dimensions of the ultrasound transmitter element
driving the at least one ultrasound transmitter element with the driving signal,
sensing ultrasound waves,
generating a sensing signal in response to sensed ultrasound waves, and
determining a frequency spectrum of the sensing signal.

14. System comprising:
an ultrasound measurement assembly as claimed in claim 1, and
an evaluation unit for evaluating the determined frequency spectrum of the sensing signal.

15. System as claimed in claim 14, further comprising a control unit for controlling an electrical device, in particular a lighting device, an alarm device, a ranging device, a guidance device, a audio and/or video playback device or a vehicle, based on the result of said evaluation.
